(19) United States
(12) Patent Application Publication
(10) Pub. No.: US 2025/0350818 A1
(43) Pub. Date: Nov. 13, 2025

(54) CAMERA MODULE

(71) Applicant: Samsung Electro-Mechanics Co., Ltd., Suwon-si (KR)

(72) Inventors: Kangjin LEE, Suwon-si (KR); Sangsun HWANG, Suwon-si (KR)

(73) Assignee: Samsung Electro-Mechanics Co., Ltd., Suwon-si (KR)

(21) Appl. No.: 19/012,341

(22) Filed: Jan. 7, 2025

(30) Foreign Application Priority Data
May 7, 2024 (KR) 10-2024-0060027
Jul. 4, 2024 (KR) 10-2024-0088362

(51) Int. Cl. H04N 23/51; G03B 5/00; G03B 13/36; G03B 30/00; H04N 23/54

(52) U.S. Cl. CPC H04N 23/51; G03B 5/00; G03B 13/36; G03B 30/00; G03B 2205/0007; G03B 2205/0046; H04N 23/54

(57) ABSTRACT

A camera module includes a lens barrel; a sub-housing disposed on one side of the lens barrel in an optical axis direction of the lens barrel, wherein an optical filter is mounted on the sub-housing; an image sensor disposed on one side of the optical filter in the optical axis direction; and a substrate electrically connected to the image sensor. The sub-housing includes a first surface facing the optical axis direction, a second surface facing a first direction intersecting the optical axis direction, a connecting portion connecting the first surface with the second surface, and a protrusion protruding from the second surface to an outer side of the sub-housing.

### CROSS-REFERENCE TO RELATED APPLICATIONS

This application claims the benefit of Korean Patent Application Nos. 10-2024-0060027 filed on May 7, 2024, and 10-2024-0088362 filed on Jul. 4, 2024, in the Korean Intellectual Property Office, the entire disclosures of which are incorporated herein by reference for all purposes.

### BACKGROUND

### 1. Field

The following description relates to a camera module.

### 2. Description of the Background

With the trend of miniaturization and slimming of portable electronic devices, including mobile phones, efforts have been made to reduce the size of components mounted on electronic devices, and integration technology for performing functions has been continuously researched and developed. For example, camera modules, which are electronic components, are adopted in camera phones, personal digital assistants (PDAs), smartphones, and notebook computers. Camera modules may include various additional functions, such as auto-focusing (AF) and optical zooming, at relatively low manufacturing costs.

A camera module may include a sub-housing equipped with an optical filter, and an actuator for implementing additional functions, such as auto-focusing and optical zooming. The size of actuators in camera modules has increased, increasing the amount of bonding desired to fix the sub-housings, which may cause a problem where adhesive flows out of camera modules.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; a sub-housing disposed on one side of the lens barrel in an optical axis direction of the lens barrel, wherein an optical filter is mounted on the sub-housing; an image sensor disposed on one side of the optical filter in the optical axis direction; and a substrate electrically connected to the image sensor. The sub-housing includes a first surface facing the optical axis direction, a second surface facing a first direction intersecting the optical axis direction, a connecting portion connecting the first surface with the second surface, and a protrusion protruding from the second surface to an outer side of the sub-housing.

The protrusion may be disposed not to overlap the substrate in the optical axis direction.

The substrate may include a first portion protruding in the first direction from a reference plane parallel to the second surface, and a second portion connected to the first portion and disposed to overlap the sub-housing in the optical axis direction. The second surface may have a first region connected to the first portion and a second region connected to the second portion, and the protrusion may be disposed in the second region.

The connecting portion may be disposed at both ends of the first surface in the first direction.

The camera module may further include: an adhesive member disposed on the connecting portion.

The adhesive member may be disposed on one edge region of the first surface.

The connecting portion may be inclined obliquely with respect to a reference line parallel to the optical axis.

The connecting portion may include a connecting surface, connected to the second surface, extending in a plane direction perpendicular to the optical axis direction and a step surface connecting the connecting surface to the first surface.

The protrusion may be disposed to be inclined obliquely with respect to a reference line parallel to the optical axis.

One end of the protrusion may be in contact with the connecting portion, and another end of the protrusion may be in contact with the second surface.

A groove portion, disposed on the connecting portion and the second surface, may extend from the connecting portion to the protrusion.

The groove portion may include at least one bend portion.

The groove portion may further include a connecting groove connecting the at least one bend portion to the protrusion and extending to be parallel to the protrusion.

The protrusion may extend in a second direction intersecting the optical axis direction and the first direction.

The protrusion may include a plurality of protrusions, and at least two protrusions of the plurality of protrusions may be disposed to face each other in the first direction.

The camera module may further include: a housing having an internal space; and a reflective module, accommodated in the internal space, including a reflective member configured to change an incident light path and a reflective holder disposed to support the reflective member, wherein the lens barrel is disposed to pass light from the incident light path.

The camera module may further include a housing having an internal space, and a lens module including a lens holder to which the lens barrel is fixed, and a driving unit configured to drive the lens barrel, wherein the lens barrel, the housing, and the image sensor are arranged in the optical axis direction.

Other features and aspects will be apparent from the following detailed description, the drawings, and the claims.

### BRIEF DESCRIPTION OF THE DRAWINGS

FIG. 1 is an exploded perspective view of a camera module according to an embodiment.

FIG. 2 is a perspective view of an image sensor module according to an embodiment.

FIG. 3 is an exploded perspective view of an image sensor module according to an embodiment.

FIG. 4 is an enlarged view of a portion of the image sensor module of FIG. 2.

FIG. 5 is an enlarged side view of a portion of the image sensor module of FIG. 2.

FIG. 6 is an enlarged view of a portion of a sub-housing according to another embodiment.

FIG. 7 is an enlarged view of a portion of a sub-housing according to another embodiment.

FIG. 8 is an exploded perspective view of a camera module according to another embodiment.

FIG. 9 is a perspective view of an image sensor module according to another embodiment.

FIG. 10 is an enlarged view of a portion of the image sensor module of FIG. 9.

FIG. 11 is an enlarged side view of a portion of the image sensor module of FIG. 10.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Throughout the specification, when it is referred to “in plan view”, it means that a target element is viewed from above, and when it is referred to “in cross-sectional view”, it means that a target element taken vertically is viewed from the side.

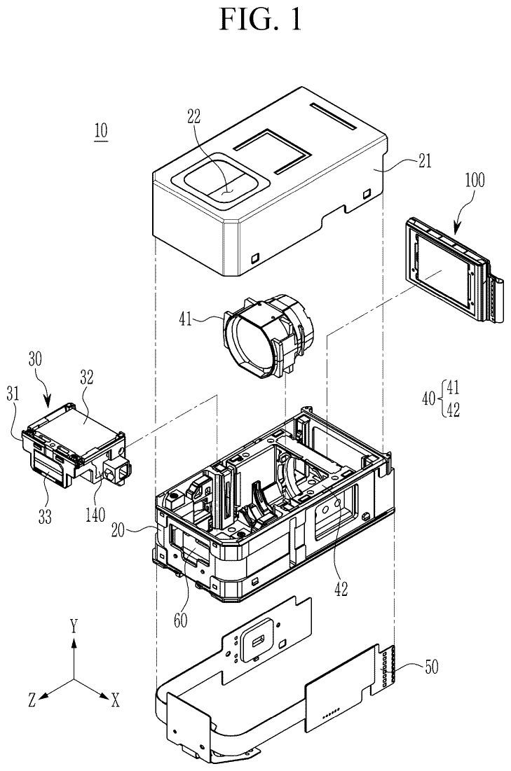

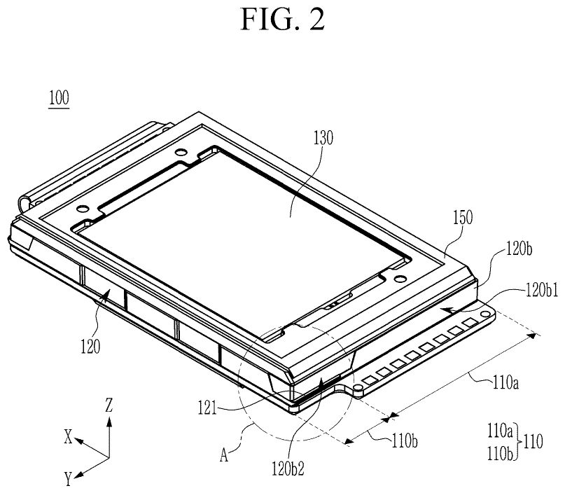

FIG. 1 is an exploded perspective view of a camera module according to an embodiment. FIG. 2 is a perspective view of an image sensor module according to an embodiment.

Referring to FIG. 1, a camera module 10, according to embodiments, may include a housing 20 having an internal space, a reflective module 30 provided in the internal space of the housing 20, a lens module 40 including at least one lens barrel, an image sensor module 100, and a cover 21 covering an upper portion of the housing 20.

The reflective module 30 may be configured to change a traveling direction of incident light. Light originating from a subject (not shown) outside the camera module 10 may change the traveling direction toward the lens module 40 through the reflective module 30. For example, light incident in a thickness direction (e.g., a Y-axis direction) of the camera module 10 through an opening 22 formed by opening at least a portion of a surface of the cover 21 may be changed in the path by the reflective module 30 to approximately match an optical axis direction (e.g., a Z-axis direction) of the lens module 40. In order to change the light path, the reflective module 30 may include a reflective member 32 that reflects light. The camera module 10, according to embodiments, may perform an optical image stabilization (OIS) function by rotating the reflective member 32 included in the reflective module 30 around a rotation axis or moving the reflective member 32 in various directions.

The camera module 10 may include a guide member 60 that guides the movement of the reflective module 30. The guide member 60 may be provided to be adjacent to the reflective module 30 and may guide the reflective module 30 to rotate around a certain axis or move in a certain direction. For example, the guide member 60 may include a ball member (not shown) or a pivot member (not shown) forming a rotation axis of the reflective module 30 or may include a rail member (not shown) forming a movement path of the reflective module 30.

The lens module 40 may include at least one lens barrel 41 that accommodates a lens through which a light change path by the reflective module 30 passes and a driving unit 42 configured to provide a driving force to the lens barrel. As the lens barrel 41 moves in the optical axis direction (the Z-axis direction) or a gap is adjusted by the driving unit 42, an auto focusing (AF) or zooming function may be implemented. Alternatively, the lens barrel 41 may move to perform an OIS function.

Referring to FIG. 2 together with FIG. 1, the image sensor module 100, including an image sensor 140 that converts light passing through the lens module into an electrical signal, may be located at the rear of the lens module 40. The image sensor module 100 may further include an optical filter 130 that filters light incident through the lens module 40.

In the camera module 10, according to embodiments, the reflective module 30 may be provided in front of the lens module 40 based on the lens module 40 in an internal space of the housing 20, and the image sensor module 100 may be provided at the rear of the lens module 40. Accordingly, incident light incident from a subject outside the camera module 10 may sequentially pass through the reflective module 30 and the lens module 40 and then be incident on the image sensor module 100.

The image sensor module 100 is electrically connected to a circuit board 50 and may transmit image information to the outside of the camera module 10 as an electrical signal.

Meanwhile, the camera module 10 may be configured by combining a reflective module assembly, including the reflective module 30, and a lens module assembly provided adjacent to the reflective module assembly. For example, the reflective module assembly may include the reflective module 30 described above and a housing having an internal space in which the reflective module 30 is movably accommodated. The lens module assembly may include the lens module 40, the image sensor module 100, and the housing having an internal space for accommodating them. The housing of the reflective module assembly and the housing of the lens module assembly may be formed integrally with each other or provided as separate housings. In this case, the separate housings may be mutually coupled to form the entire housing of the camera module 10.

The reflective module 30 may be accommodated inside the housing 20 of the camera module 10 and may change the incident light path. For example, as shown in FIG. 1, the reflective module 30 is accommodated to be adjacent to the lens module 40 inside the housing 20 so as to change the incident light path in the thickness direction (e.g., the Y-axis direction) of the camera module 10 to the optical axis direction (e.g., the Z-axis direction) of the lens module 40.

The reflective module 30 may include a reflective member 32 that may change the path of incident light, a reflective holder 31 disposed to support the reflective member 32, and a reflective driving unit 33 that moves the reflective holder 31.

The reflective member 32 of the reflective module 30 may change the traveling path of light by refracting or reflecting incident light. For example, light incident on the reflective member 32 in the Y-axis direction may be changed in a traveling path to the Z-axis direction intersecting the Y-axis direction by the reflective member 32. The reflective member 32 is provided to reflect or refract incident light. For example, the reflective member 32 may change the traveling path of light incident from an external subject to the optical axis direction (e.g., the Z-axis direction) of the lens module 40. The reflective member 32 may be a mirror or prism that reflects light, but is not limited thereto, and may be any member that may change the path of light. In the following description, it is assumed that the reflective member 32 has a prism shape.

The reflective holder 31 supports the reflective member 32 to be movable. That is, the reflective member 32 may be supported by the reflective holder 31 and may move within a predetermined range. For example, the reflective holder 31 may rotate around a rotation axis (e.g., an axis parallel to the X-axis) passing through the reflective holder 31 or may reciprocate within a predetermined range. Therefore, the reflective member 32 supported by the reflective holder 31 may rotate or reciprocate according to the movement of the reflective holder 31.

The reflective holder 31 may be formed of an injection-molded material that is easy to shape by an injection molding process. The reflective holder 31 may be formed of a material, such as resin or plastic.

The reflective driving unit 33 that moves the reflective holder 31 is provided on at least a portion of a surface of the reflective holder 31. For example, as shown in FIG. 2, the reflective driving unit 33 may be provided at an end portion of the reflective holder 31 in one direction (e.g., the Z-axis direction). In addition, the reflective driving unit 33 may be provided at an end portion of the reflective holder 31 in the other direction (e.g., in the Y-axis direction). The reflective driving unit 33 may be an electromagnetic actuator including a magnet and a coil, but it is not limited thereto, and it may be any unit that may move the reflective holder 31 within a certain range.

Meanwhile, the reflective module 30 may further include a position detection unit (not shown) that detects the amount of movement of the reflective holder 31.

The reflective module 30 may perform an OIS function by rotating or moving the reflective holder 31 and the reflective member 32 supported by the reflective holder 31 inside the housing 20 through driving force generated by the reflection driving unit 33.

A focal length may be adjusted as the lens barrel 41 reciprocates along the optical axis. The driving unit 42 may be disposed on one side of the lens barrel 41. For example, the driving unit 42 may include a magnet, a coil disposed at a position facing the magnet, and a carrier configured to move the lens barrel 41. The lens barrel 41 may move along the optical axis by an electromagnetic interaction between the coil and the magnet. The coil may be mounted on a circuit board 50 attached to the housing 20.

A plurality of ball members (not shown) may be arranged between the lens module 40 and the bottom surface of the housing 20. The bottom surface of the lens module 40 and the housing 20 may include a plurality of guide grooves that accommodate at least one of the plurality of ball members. The plurality of guide grooves may extend in a direction parallel to the optical axis, and a direction of movement of the plurality of ball members may be limited to an extension direction (i.e., the optical axis direction) of the plurality of guide grooves.

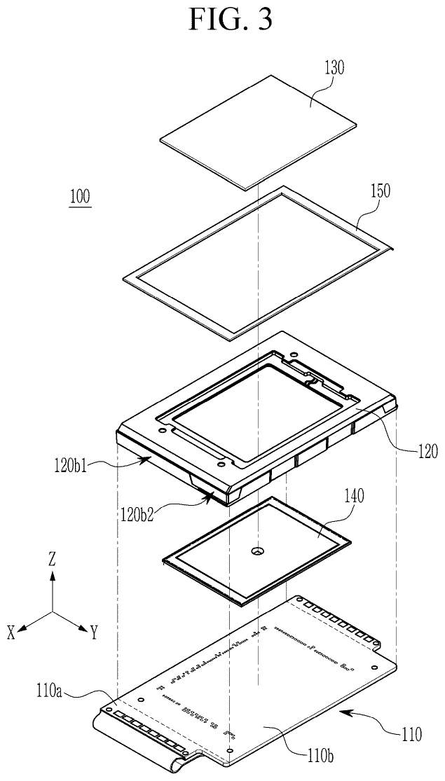

Hereinafter, the image sensor module 100 is described in more detail with reference to FIGS. 2 and 3.

FIG. 3 is an exploded perspective view of an image sensor module according to an embodiment.

Referring to FIGS. 2 and 3, the image sensor module 100 may include a substrate 110, a sub-housing 120 disposed on one side of the lens module 40 in the optical axis direction of the lens module 40, an optical filter 130 mounted on the sub-housing 120, an image sensor 140 disposed on one side of the optical filter 130 in the optical axis direction, and an adhesive member 150.

The substrate 110 may be disposed on one side of the sub-housing 120 in the optical axis direction. The substrate 110 may be electrically connected to the image sensor 140. For example, the substrate 110 may include an image sensor mounting portion (not shown). The image sensor mounting portion may have a shape corresponding to the shape of the image sensor 140 and may have an approximately rectangular shape.

The image sensor 140 may be mounted on the substrate 110. The image sensor 140 may be located below the lens barrel 41 in the optical axis direction. The image sensor 140 may convert light incident through the lens module 40 into an electrical signal. For example, the image sensor 140 may be a charge coupled device (CCD) or complementary metal-oxide semiconductor (CMOS). The electrical signal converted by the image sensor 140 may be output as an image through a display unit (not shown) of an electronic device equipped with the camera module 10. The image sensor 140 may be fixed to the substrate 110 and may be electrically connected to the substrate 110. The image sensor 140 may have, for example, a rectangular plate shape. The image sensor 140 may have a rectangular shape with a longer side and a shorter side.

The sub-housing 120 may include an opening, and light passing through the lens module 40 may pass through the opening of the sub-housing 120 and be received by the image sensor 140. The sub-housing 120 may have a rectangular shape with long sides and short sides.

The optical filter 130 may be mounted on the sub-housing 120. For example, the optical filter 130 may block light in an infrared range among the light passing through the lens module 40.

The adhesive member 150 may serve to adhere the sub-housing 120 to the lens module 40. The adhesive member 150 may be applied to one surface of the sub-housing 120 to bond the sub-housing 120 to the lens module 40.

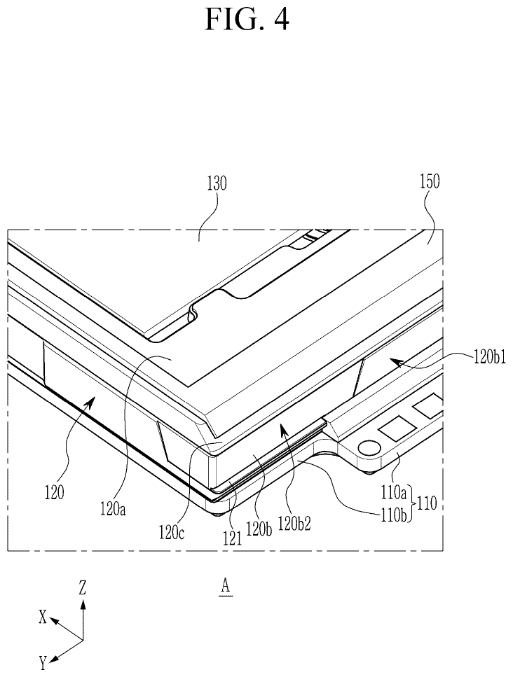

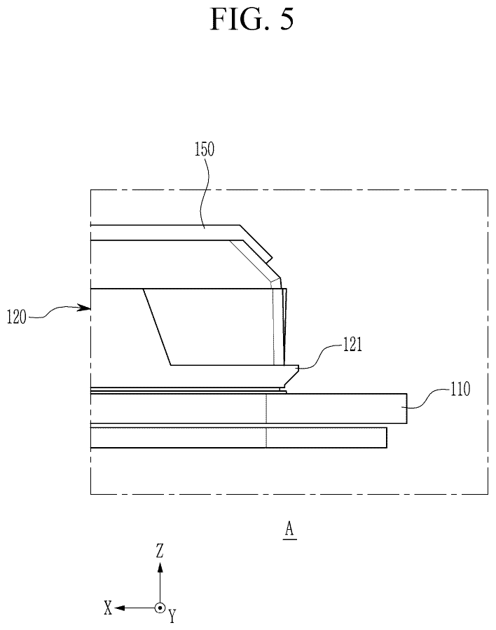

Hereinafter, the sub-housing 120 is described in more detail with reference to FIGS. 4 and 5 together with FIGS. 2 and 3.

FIG. 4 is an enlarged view illustrating a portion of the image sensor module of FIG. 2, and FIG. 5 is an enlarged side view illustrating a portion of the image sensor module of FIG. 2. FIGS. 4 and 5 are enlarged views illustrating region A of FIG. 2.

Referring to FIGS. 4 and 5, the sub-housing 120 may have a first surface 120a facing in the optical axis direction and a second surface 120b facing in the X-axis direction intersecting the optical axis direction. The sub-housing 120 may include a connecting portion 120c connecting the first surface 120a with the second surface 120b. The sub-housing 120 may include a protrusion 121 that protrudes outwardly from the second surface 120b in the X-axis direction of the sub-housing 120.

For example, the first surface 120a may have a shape extending in a plane perpendicular to the optical axis. The second surface 120b may have a shape that extends in a plane perpendicular to the first surface 120a. The connecting portion 120c may be disposed at both ends of the first surface 120a in the X-axis direction. The connecting portion 120c may extend along a shorter side of the sub-housing 120. The connecting portion 120c may include an inclined surface obliquely inclined with respect to a reference line parallel to the optical axis.

The adhesive member 150 may be disposed on the first surface 120a. The adhesive member 150 may be disposed on one edge region of the first surface 120a. The adhesive member 150 may be disposed to surround the edge of the first surface 120a. The adhesive member 150 may be disposed on the connecting portion 120c.

During the process in which the lens module 40 and the sub-housing 120 are pressed toward each other and bonded, a portion of the adhesive member 150 may overflow and flow out of the sub-housing 120. The adhesive member 150 flowing outwardly may flow along the second surface 120b of the sub-housing 120. Here, the flowed-out adhesive member 150 may settle on the protrusion 121. Therefore, it is possible to prevent appearance defects from occurring due to the adhesive member 150 being stuck on the outer side of the camera module 10 or the side surface of the substrate 110.

Referring to FIGS. 2 to 5, the substrate 110 may include a first portion 110a protruding in the X-axis direction from a reference plane parallel to the second surface 120b and a second portion 110b connected to the first portion 110a and disposed to overlap the sub-housing 120 in the optical axis direction. The second portion 110b may refer to a portion of the substrate on which the sub-housing 120 is disposed. The second portion 110b may have a shape corresponding to the sub-housing 120. The other region of the substrate 110, excluding the second portion 110b, may be the first portion 110a. In other words, in an X-Y plane, the portion of the substrate 110 that protrudes outwardly from the sub-housing 120 may be the first portion 110a, and the portion covered by the sub-housing 120 may be the second portion 110b.

The second surface 120b of the sub-housing 120 may be divided into a first region 120b1 and a second region 120b2. The first region 120b1 may be a region connected to the first portion 110a. The first region 120b1 may be connected to the first portion 110a at one end. The second region 120b2 may be a region connected to the second portion 110b. The second region 120b2 may be connected to the second portion 110b at one end. A protrusion 121 may be located on at least a portion of the second region 120b2. In other words, the protrusion 121 may be disposed not to overlap the substrate 110 in the optical axis direction. The protrusion 121 may be disposed not to overlap the second portion 110b of the substrate 110 in the optical axis direction.

The protrusion 121 may extend in the Y-axis direction. The Y-axis direction may be a direction intersecting the optical axis direction and the X-axis direction. The Y-axis direction may be a direction parallel to one edge of the second surface 120b. For example, the protrusion 121 may be provided in plurality. At least two of the plurality of protrusions 121 may be disposed to face each other in the X-axis direction.

Referring to FIG. 1, the lens module 40 may have a third surface disposed to face the first surface 120a of the sub-housing 120 at one end. The third surface may be parallel to the first surface 120a. The lens module 40 may have a fourth surface connected to the third surface and disposed to face the connecting portion 120c. The fourth surface may be parallel to the connecting portion 120c. The fourth surface may be disposed at both ends of the third surface in the X-axis direction. The adhesive member 150 may be disposed between the first surface 120a of the sub-housing and the third surface of the lens module 40. The adhesive member 150 may be disposed between the connecting portion 120c of the sub-housing 120 and the fourth surface of the lens module 40.

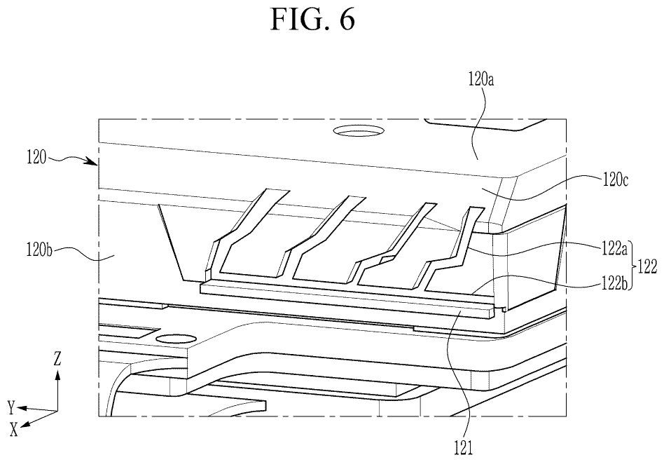

Hereinafter, a camera module, according to another embodiment, is described with reference to FIG. 6.

FIG. 6 is an enlarged view of a portion of a sub-housing according to another embodiment.

Referring to FIG. 6, the camera module 10 is similar to the camera module 10 according to the embodiment described above with reference to FIGS. 1 to 5. A detailed description of the same components is omitted. The camera module 10 of FIG. 6 may be similar to the camera module 10 of FIGS. 1 to 5, except that the sub-housing 120 has a groove portion 122.

Referring to FIG. 6, the camera module 10, according to another embodiment, may have the groove portion 122 extending from the connecting portion 120c to the protrusion 121, compared to the camera module according to an embodiment illustrated in FIGS. 1 to 5. The groove portion 122 may be disposed on the connecting portion 120c and the second surface 120b.

The groove portion 122 may have at least one bent portion 122a. When the adhesive member 150 disposed on the connecting portion 120c flows, the bent portion 122a may guide the adhesive member 150 to settle on the protrusion 121, thereby preventing the flowed-down adhesive member 150 from causing an appearance defect of the camera module 10. The adhesive member 150 may flow down along the groove portion 122 and be disposed on the protrusion 121.

The groove portion 122 may have at least one connecting groove 122b connecting the bent portion 122a to the protrusion 121. When the bent portion 122a is provided in plurality, the plurality of bent portions 122a may be connected to the connecting groove 122b at one end. The connecting groove 122b may extend parallel to the protrusion 121. The connecting groove 122b may extend in the Y-axis direction. Therefore, the adhesive member 150 flowing along the bent portion 122a may stay in the connecting groove 122b and may be prevented from overflowing from the protrusion 121.

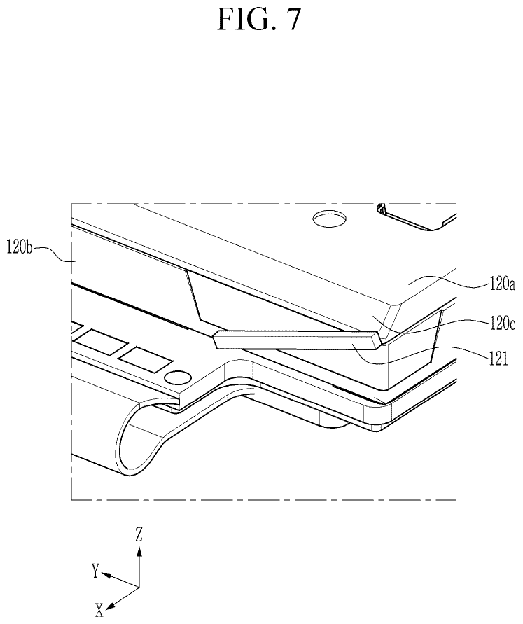

Hereinafter, a camera module, according to another embodiment, is described with reference to FIG. 7.

FIG. 7 is an enlarged view of a portion of a sub-housing according to another embodiment.

Referring to FIG. 7, a camera module 10, according to another embodiment, is similar to the camera module 10 according to the embodiment described above with reference to FIGS. 1 to 5. A detailed description of the same components is omitted. The camera module 10 of FIG. 7 may be similar to the camera module 10 of FIGS. 1 to 5, except for the shape of the protrusion 121.

Referring to FIG. 7, a camera module 10, according to another embodiment, may be disposed so that the protrusion 121 is inclined obliquely with respect to the reference line parallel to the optical axis, compared to the camera module according to an embodiment illustrated in FIGS. 1 to 5. The protrusion 121 may extend from the connecting portion 120c of the sub-housing 120 to the second surface 120b. One end of the protrusion 121 may be in contact with the connecting portion 120c of the sub-housing 120. The other end of the protrusion 121 may be in contact with the second surface 120b of the sub-housing 120. The height of one end of the protrusion 121 in the optical axis direction may be higher than the height of the other end. The height of the protrusion 121 with respect to the substrate 110 may decrease from the outside to the inside of the sub-housing 120.

The adhesive member 150 disposed on the connecting portion 120c or the first surface 120a may flow to the substrate 110 along the slope of the protrusion 121. Therefore, the protrusion 121 may guide the adhesive member 150 to settle on the first portion 110a of the substrate 110. That is, the protrusion 121 may prevent the flowed-down adhesive member 150 from causing an appearance defect of the camera module 10.

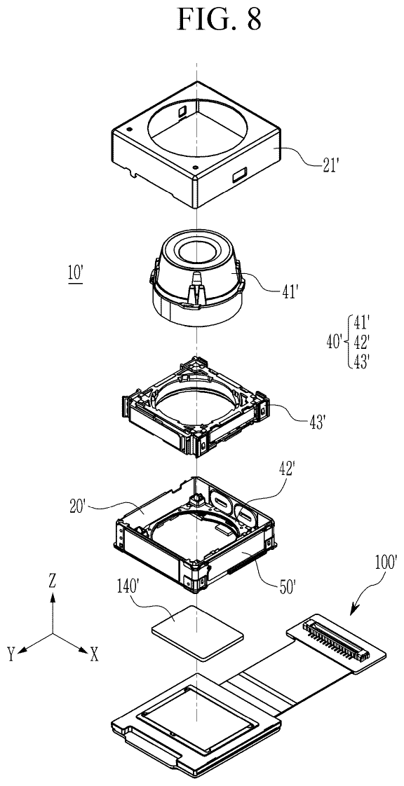

Hereinafter, a camera module, according to another embodiment, is described with reference to FIGS. 8 to 11.

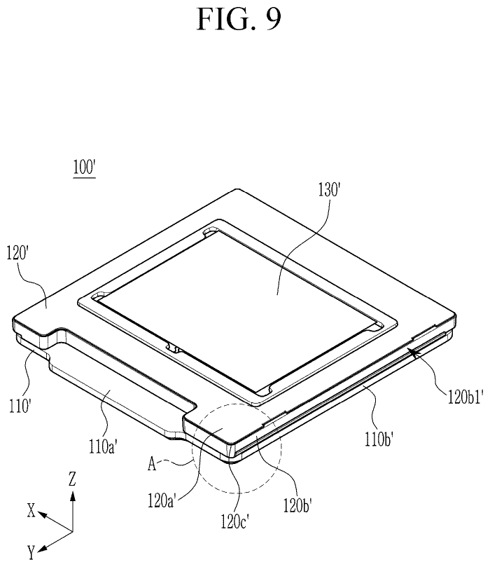

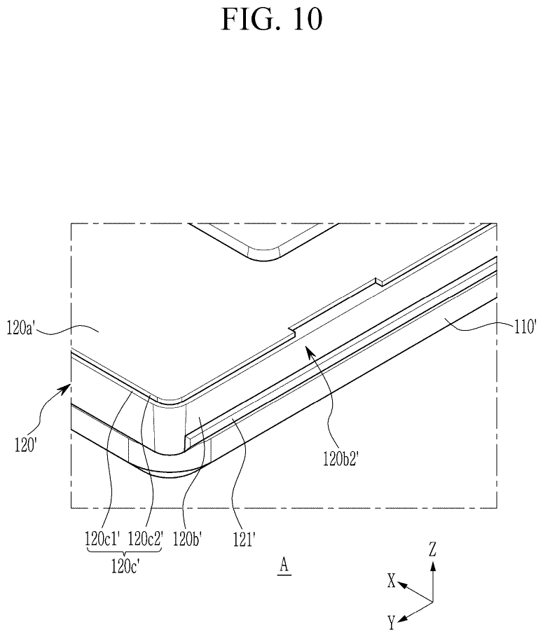

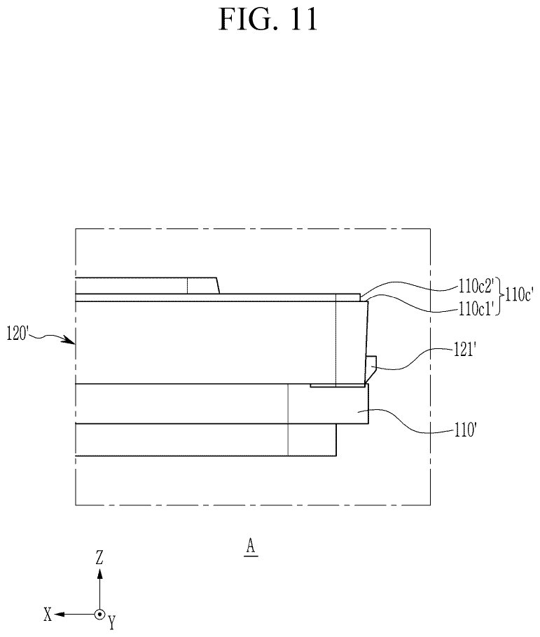

FIG. 8 is an exploded perspective view of a camera module according to another embodiment, FIG. 9 is a perspective view of an image sensor module according to another embodiment, FIG. 10 is an enlarged view illustrating a portion of the image sensor module of FIG. 9, and FIG. 11 is a side view illustrating a portion of the image sensor module of FIG. 10. FIGS. 10 and 11 are enlarged views of region A of FIG. 2.

Referring to FIGS. 8 to 11, a camera module 10′ according to another embodiment is similar to the camera module 10 according to the embodiment described above with reference to FIGS. 1 to 5. A specific description of the same components is omitted. The camera module 10′ of FIGS. 8 to 11 may be similar to the camera module 10 of FIGS. 1 to 5, except for the configuration and arrangement of a lens module 40′ and the arrangement of a housing 20′. In addition, the camera module 10′ of FIGS. 8 to 11 may be similar to the camera module 10 of FIGS. 1 to 5, except that the camera module 10′ does not include the reflective module 30.

Referring to FIGS. 8 to 11, in the camera module 10′ according to another embodiment, components and arrangements of the components of the camera module 10′ may be different, compared to the camera module 10 according to the embodiment illustrated in FIGS. 1 to 5.

Referring to FIG. 8, the camera module 10′, according to another embodiment, may include the housing 20′, a cover 21′, the lens module 40′, a circuit board 50′, and an image sensor module 100′. The lens module 40′ may include a lens barrel 41′, a driving unit 42′, and a lens holder 43′.

The housing 20′ may have an internal space. The housing 20′ may accommodate the lens barrel 41′, the driving unit 42′, and the lens holder 43′. The housing 20′ may have a polyhedral shape with a substantially rectangular cross-section and a predetermined height. However, the shape of the housing 20′ is not limited to the polyhedral shape having a rectangular cross-section. The housing 20′ may be covered with the cover 21′.

The cover 21′ may be coupled to the housing 20′ to cover an outer surface of the housing 20′ and may have a function of protecting internal components of the camera module 10′. In addition, the cover 21′ may have a function of shielding electromagnetic waves.

The lens module 40′ may include a lens barrel 41′ that accommodates a lens through which light passes and a driving unit 42′ configured to provide driving force to the lens barrel. As the lens barrel 41′ moves in the optical axis direction (the Z-axis direction) or a gap is adjusted by the driving unit 42′, an auto-focusing (AF) or zoom function may be implemented. Alternatively, the lens barrel 41′ may move to perform an OIS function.

The lens barrel 41′ may have a hollow cylindrical shape so that at least one lens for imaging a subject may be accommodated therein, and the at least one lens may be mounted on the lens barrel 41′ along the optical axis. A plurality of lenses may be arranged as many as needed according to the design of the lens barrel 41′, and each lens may have optical characteristics, such as a refractive index that is the same or different. The lens barrel 41′ may move in the optical axis direction or in a direction perpendicular to the optical axis, while being accommodated in the housing 20′ by driving force of the driving unit 42′.

The driving unit 42′ may provide driving force desired to drive the lens barrel 41′. For example, the driving unit 42′ may include a magnet, a coil located to face the magnet, and a carrier configured to move the lens barrel 41′. The lens barrel 41′ may move along the optical axis by an electromagnetic interaction between the coil and the magnet. The coil may be mounted on a circuit board 50′ attached to the housing 20′.

The driving unit 42′, as a device for moving the lens barrel 41′, may include an AF unit for adjusting focus and an OIS unit for correcting hand shake or shaking. For example, the driving unit 42′ may adjust the focus or implement a zoom function by moving the lens barrel 41′ in the optical axis direction (the Z-axis direction) using the AF unit. In addition, the driving unit 42′ may correct hand shake or shaking during image capturing by moving the lens barrel 41′ in the direction (the X-axis direction or Y-axis direction) perpendicular to the optical axis direction using the OIS unit.

The lens barrel 41′ may be fixed to the lens holder 43′. The lens barrel 41′ may be inserted and fixed into the lens holder 43′. A portion of the driving unit 42′ may be disposed on one side of the lens holder 43′. The magnet of the driving unit 42′ may be disposed on one surface of the lens holder 43′.

An image sensor module 100′ including an image sensor 140′ (see FIG. 8) that converts light passing through the lens module into an electrical signal may be located at the rear of the lens module 40′. The image sensor module 100′ may further include an optical filter 130′ that filters light incident through the lens module 40′. The lens barrel 41′ and the image sensor 140′ may be arranged in the optical axis direction to receive light incident in the optical axis direction (the Z-axis direction). The lens barrel 41′, the housing 20′, and the image sensor 140′ may be arranged in the optical axis direction.

Hereinafter, a sub-housing 120′ of the camera module 10′, according to another embodiment, will be described in more detail with reference to FIGS. 9 to 11.

Another embodiment of the image sensor module 100′ is similar to the embodiment of the image sensor module 100 described above with reference to FIGS. 1 to 5, except for the shape of the substrate 110′ and the sub-housing 120′. A detailed description of the same components is omitted. The image sensor module 100′ of FIGS. 9 to 11 may be similar to the image sensor module 100 of FIGS. 1 to 5, except for the shape and configuration of the connecting portion 120c′. In addition, the image sensor module 100′ of FIGS. 9 to 11 may be similar to the image sensor module 100 of FIGS. 1 to 5, except for the arrangement of the first portion 110a′, the second portion 110b′, the first region 120b1′, the second region 120b2′, and the shape of a protrusion 121′.

In FIG. 9, the adhesive member 150 (see FIG. 2, etc.) is omitted, but, as in the camera module 10 according to an embodiment, the adhesive member 150 may be applied to one surface of the sub-housing 120′ to bond the sub-housing 120′ to the lens module 40′.

Referring to FIGS. 9 to 11, the sub-housing 120′ may have a first surface 120a′ facing in the optical axis direction and a second surface 120b′ disposed to intersect the first surface 120a′ and facing in the X-axis direction. The sub-housing 120′ may include a connecting portion 120c′ connecting the first surface 120a′ to the second surface 120b′. The sub-housing 120′ may include the protrusion 121′ located on the second surface 120b′ and protruding outwardly of the sub-housing 120′ in the X-axis direction.

For example, the first surface 120a′ may have a shape extended as a plane perpendicular to the optical axis direction. The second surface 120b′ may have a shape extended as a plane perpendicular to the first surface 120a′. The connecting portion 120c′ may extend along the edge of the sub-housing 120′.

Referring to FIGS. 9 to 11, the connecting portion 120c′ may include a connecting surface 120c1′ connected to the second surface 120b′ and extending in a plane direction perpendicular to the optical axis direction and a step surface 120c2′ connecting the connecting surface 120c1′ to the first surface 120a′. There may be a step between the connecting surface 120c1′ and the first surface 120a′. The step surface 120c2′ may extend in a direction parallel to the second surface 120b′. The step surface 120c2′ may be parallel to the second surface 120b′. Since the connecting portion 120c′ has the step surface 120c2′, the adhesive member 150 flowing from the first surface 120a′ may settle on the step surface 120c2′, thereby preventing the adhesive member 150 from being exposed to the outside of the camera module 10′ and causing an appearance defect.

The adhesive member 150 (see FIG. 2, etc.) may be disposed on the first surface 120a′. The adhesive member 150 may be disposed on one edge region of the first surface 120a′. The adhesive member 150 may be disposed to surround the edge of the first surface 120a′. The adhesive member 150 may be disposed on the connecting portion 120c′.

In the process in which the lens module 40′ and the sub-housing 120′ are pressed toward each other and bonded, a portion of the adhesive member 150 may overflow and flow outwardly of the sub-housing 120′. The adhesive member 150 flowing outwardly may flow along the second surface 120b′ of the sub-housing 120′. Here, the flowed-out adhesive member 150 may settle on the protrusion 121′. Therefore, it is possible to prevent appearance defects from occurring due to the adhesive member 150 being stuck on the outside of the camera module 10′ or the side surface of the substrate 110′.

The substrate 110′ may include the first portion 110a′ protruding in the X-axis direction from the reference plane parallel to the second surface 120b, and the second portion 110b′ connected to the first portion 110a′ and disposed to overlap the sub-housing 120′ in the optical axis direction. The second portion 110b′ may refer to a portion of the substrate 110′ on which the sub-housing 120′ is disposed. The second portion 110b′ may have a shape corresponding to the sub-housing 120′. The other region of the substrate 110′, excluding the second portion 110b′, may be the first portion 110a′. In other words, in the X-Y plane, the portion of the substrate 110′ that protrudes outwardly from the sub-housing 120′ may be the first portion 110a′ and the portion covered with the sub-housing 120′ may be the second portion 110b′.

The second surface 120b′ of the sub-housing 120′ may be divided into a first region 120b1′ and a second region 120b2′. The first region 120b1′ may be connected to the first portion 110a′. The first region 120b1′ may be connected to the first portion 110a′ at one end. The second region 120b2′ may be connected to the second portion 110b′. The second region 120b2′ may be connected to the second portion 110b′ at one end. The protrusion 121′ may be located on at least a portion of the second region 120b2′. In other words, the protrusion 121′ may be located not to overlap the substrate 110′ in the optical axis direction. The protrusion 121′ may be located not to overlap the second portion 110b′ of the substrate 110′ in the optical axis direction.

The protrusion 121′ may extend in the Y-axis direction. The Y-axis direction may be a direction intersecting the optical axis direction and the X-axis direction. The Y-axis direction may be a direction parallel to one edge of the second surface 120b′. For example, the protrusion 121′ may be provided in plurality. At least two of the plurality of protrusions 121′ may be located to face each other in the X-axis direction.

The lens module 40 (see FIG. 8) may have a third surface disposed to face the first surface 120a′ of the sub-housing 120′. The third surface may be parallel to the first surface 120a′. The lens module 40′ may have a fourth surface connected to the third surface and disposed to face the connecting portion 120c′. The fourth surface may be disposed at both ends of the third surface in the X-axis direction.

According to one or more embodiments, the camera module has a protrusion on one side of the sub-housing to prevent the adhesive member from flowing outwardly and prevent the appearance of the camera module from being defective.

One or more embodiments are directed to a camera module capable of preventing appearance defects due to adhesive members, while securing adhesion between a sub-housing and a lens module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel;
a sub-housing disposed on one side of the lens barrel in an optical axis direction of the lens barrel, wherein an optical filter is mounted on the sub-housing;
an image sensor disposed on one side of the optical filter in the optical axis direction; and
a substrate electrically connected to the image sensor,
wherein the sub-housing comprises
a first surface facing the optical axis direction,
a second surface facing a first direction intersecting the optical axis direction,
a connecting portion connecting the first surface with the second surface, and
a protrusion protruding from the second surface to an outer side of the sub-housing.

2. The camera module of claim 1, wherein the protrusion is disposed not to overlap the substrate in the optical axis direction.

3. The camera module of claim 1, wherein
the substrate comprises a first portion protruding in the first direction from a reference plane parallel to the second surface, and a second portion connected to the first portion and disposed to overlap the sub-housing in the optical axis direction,
the second surface has a first region connected to the first portion and a second region connected to the second portion, and
the protrusion is disposed in the second region.

4. The camera module of claim 1, wherein the connecting portion is disposed at both ends of the first surface in the first direction.

5. The camera module of claim 1, further comprising:
an adhesive member disposed on the connecting portion.

6. The camera module of claim 5, wherein the adhesive member is disposed on one edge region of the first surface.

7. The camera module of claim 1, wherein the connecting portion is inclined obliquely with respect to a reference line parallel to the optical axis.

8. The camera module of claim 1, wherein the connecting portion comprises a connecting surface, connected to the second surface, extending in a plane direction perpendicular to the optical axis direction, and a step surface connecting the connecting surface to the first surface.

9. The camera module of claim 1, wherein the protrusion is disposed to be inclined obliquely with respect to a reference line parallel to the optical axis.

10. The camera module of claim 9, wherein one end of the protrusion is in contact with the connecting portion, and another end of the protrusion is in contact with the second surface.

11. The camera module of claim 1, wherein a groove portion, disposed on the connecting portion and the second surface, extends from the connecting portion to the protrusion.

12. The camera module of claim 11, wherein the groove portion comprises at least one bend portion.

13. The camera module of claim 12, wherein the groove portion further comprises a connecting groove connecting the at least one bend portion to the protrusion and extending to be parallel to the protrusion.

14. The camera module of claim 1, wherein the protrusion extends in a second direction intersecting the optical axis direction and the first direction.

15. The camera module of claim 1, wherein the protrusion comprises a plurality of protrusions, and
at least two protrusions of the plurality of protrusions are disposed to face each other in the first direction.

16. The camera module of claim 1, further comprising:
a housing having an internal space; and
a reflective module, accommodated in the internal space, comprising a reflective member configured to change an incident light path and a reflective holder disposed to support the reflective member,
wherein the lens barrel is disposed to pass light from the incident light path.

17. The camera module of claim 1, further comprising:
a housing having an internal space, and
a lens module comprising a lens holder to which the lens barrel is fixed, and a driving unit configured to drive the lens barrel,
wherein the lens barrel, the housing, and the image sensor are arranged in the optical axis direction.
